(19) United States
(12) Patent Application Publication
(10) Pub. No.: US 2009/0134635 A1
(43) Pub. Date: May 28, 2009

(54) DOOR BOLT ASSEMBLY

(76) Inventor: Steve E. Lashley, Sr., Naples, FL (US)

Correspondence Address: EDWARD M. LIVINGSTON, PA, 963 TRAIL TERRACE DRIVE, NAPLES, FL, 34103, US

(21) Appl. No.: 11/945,582

(22) Filed: Nov. 27, 2007

(51) Int. Cl. E05C 1/00

(52) U.S. Cl. 292/143

(57) ABSTRACT

A door bolt assembly (1) having an actuating lever (5) operably connected to a slidable housing (11), a locking block (12) attached to the slidable housing (11) an extension rod (6). The extension rod (6), which may include at least one extension support tip (7) attached thereto, extends a predetermined distance into the locking block (12) and terminates within the locking block (12). The locking block (12), in turn, is attached to the slidable housing (11) via a bolt (16) and is held in a predetermined position by securing the bolt (16) to the slidable housing (11).

### BACKGROUND OF THE INVENTION

This invention relates to door bolt assemblies, more particularly, a door bolt assembly having a locking block which prevents loosening of an extension bolt located within the door bolt system.

Currently, door bolt assemblies, also known as extension bolts, are commonly used in doors to add an additional level of security, be it from outside intruders, severe weather conditions, etc., to one's home and/or business. The door bolt assemblies include a slidable extension bolt wherein a user manipulates a lever, which is commonly located at the top and/or at the bottom of a door, to extend the extension bolt through the door and partially into the frame surrounding the door. The use of such extension bolts reduces and/or eliminates the flexing of the “sail area” of the door, that is, the area of the door located between the door handle, the uppermost portion of an uppermost door hinge and the top of the door. Although the use of such door bolt assemblies adds an extra layer of security, there exists room for improvement.

For instance, most door bolt assemblies are faulty in that, over the course of time and use, the extension bolt to lever attachment becomes loose, thereby requiring repair, and possibly even replacement, of the door bolt assembly.

In addition, because most door bolt assemblies are only located at the top or bottom of a door, the integrity of the door lock itself is minimized as the door lock is unsupported.

Thus, a need exists for a durable door bolt assembly that safely secures a door in a closed, locked position while reducing and/or eliminating flexing of the sail area of the door.

The relevant prior art includes the following patents:

| Patent No. | | |
|---|---|---|
| (U.S. unless | | Issue/Publication |
| stated otherwise) | Inventor | Date |
| 2,893,773 | Clifton, Jr. | Jul. 07, 1959 |
| 5,076,620 | Campbell et al. | Dec. 31, 1991 |
| 4,005,886 | Lirette | Feb. 01, 1977 |
| 4,204,369 | Hubbard | May 27, 1980 |
| 5,590,919 | Germano | Jan. 07, 1997 |
| 1,822,279 | Ellingson | Sep. 08, 1931 |
| 3,940,886 | Ellingson, Jr. | Mar. 02, 1976 |
| 2006/0192394 | Cennamo, Jr. | Aug. 31, 2006 |
| 7,201,408 | Cennamo, Jr. | Apr. 10, 2007 |

### SUMMARY OF THE INVENTION

The primary object of the present invention is to provide a door bolt assembly that securely retains a door in a closed position under excessive force.

A further object of the present invention is to provide a door bolt assembly that reduces and/or eliminates the flexing of the sail area of the door.

An even further object of the present invention is to provide a door bolt assembly that is durable.

An even further object of the present invention is to provide a door bolt assembly that is easy to use.

Another object of the present invention is to provide a do or bolt assembly that provides additional support to a door top and a door lock.

The present invention fulfills the above and other objects by providing a door bolt assembly comprised of an actuating lever operably connected to a slidable housing, a locking block attached to the slidable housing and an extension bolt. The extension bolt, which may include at least one extension support tip attached thereto, extends a predetermined distance into the locking block and terminates within the locking block. The locking block, in turn, is attached to the slidable housing via a locking means, such as a bolt, and is held in a predetermined position by securing the locking means to the slidable housing.

To use the present invention, a person mounts the slidable bolt assembly at a predetermined location on the door, preferably above the door handle. Then, the person engages the bolt assembly by sliding actuating lever in a downward direction or disengages the bolt assembly by sliding the actuating lever in an upward direction. Because the extension bolt with or without the extension support tips, extends a predetermined distance from the door lock into the door frame, the integrity of the door lock is increased. In addition, because the extension bolt is secured within the locking block and the locking block is secured to the slidable housing via the locking means, rotation and movement of the locking block, and thus extension bolt, is prevented.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a partial front plan view of the door bolt assembly of the present invention installed on a door;

FIG. 2 is a side plan view of the door bolt assembly by itself;

FIG. 3 is a front plan view of the embodiment of FIG. 2;

FIG. 4 is a rear plan view of the embodiment of FIG. 2;

FIG. 5 is a side plan view of the door bolt assembly of the present invention in use;

FIG. 6 is a side plan view of a locking block of the door bolt assembly of the present invention; and

FIG. 7 is a top view of a locking block of the door bolt assembly of the present invention.

### DESCRIPTION OF THE PREFERRED EMBODIMENTS

For purposes of describing the preferred embodiment, the terminology used in reference to the numbered components in the drawings is as follows:
1. door bolt assembly, generally
2. door
3. door frame
4. door handle
5. actuating lever
6. extension rod means
7. extension support tip
8. extension support tip housing
9. mounting plate
10. mounting plate aperture
11. slidable housing
12. locking block
13. first arm
14. second arm
15. locking means
16. bolt
17. head
18. finger recess
19. tension spring
20. extension rod retaining
21. bolt retaining means
22. locking block recess
23. locking block aperture
24. door fastening means
25. extension rod first end
26. extension rod second end
27. first arm aperture
28. second arm aperture

With reference to FIG. 1, a partial front plan view of the door bolt assembly of the present invention installed on a door is shown. The door bolt assembly, generally 1, is secured to a door 2, preferably above a door handle 4 located near a middle area of the door 2. However, the door bolt assembly 1 may also be secured to an uppermost or lowermost area of a door 2 or in any other location on the door 2 as desired. The door bolt assembly 1 includes an actuating lever 5 that permits an extension rod 6 and attached extension support tip 7, which is preferably extendable through an extension support tip housing 8, to move in an upward and downward motion relative to the door 2. When the door bolt assembly 1 is in an engaged position, that is, when the extension rod 6 is in its uppermost position when the actuating lever 5 is moved downward, the extension support tip 7 is positioned within a door frame 3. If an extension support tip 7 is not utilized, the extension rod 6 may be of such a length so as to extend through the door 2 and into the door frame 3. Because the extension rod 6 and extension support tip 7 (if utilized) extend through a substantial portion of the door 2, namely through the middle area of the door 2 to its uppermost or lowermost area of the door 2, which are areas of the door 2 not typically having reinforcing support therein, and into the door frame 3, the sail area of the door 2 is secured, thereby reducing and/or eliminating the flexing of the sail area of the door 2, and the door handle 4 is afforded additional supported.

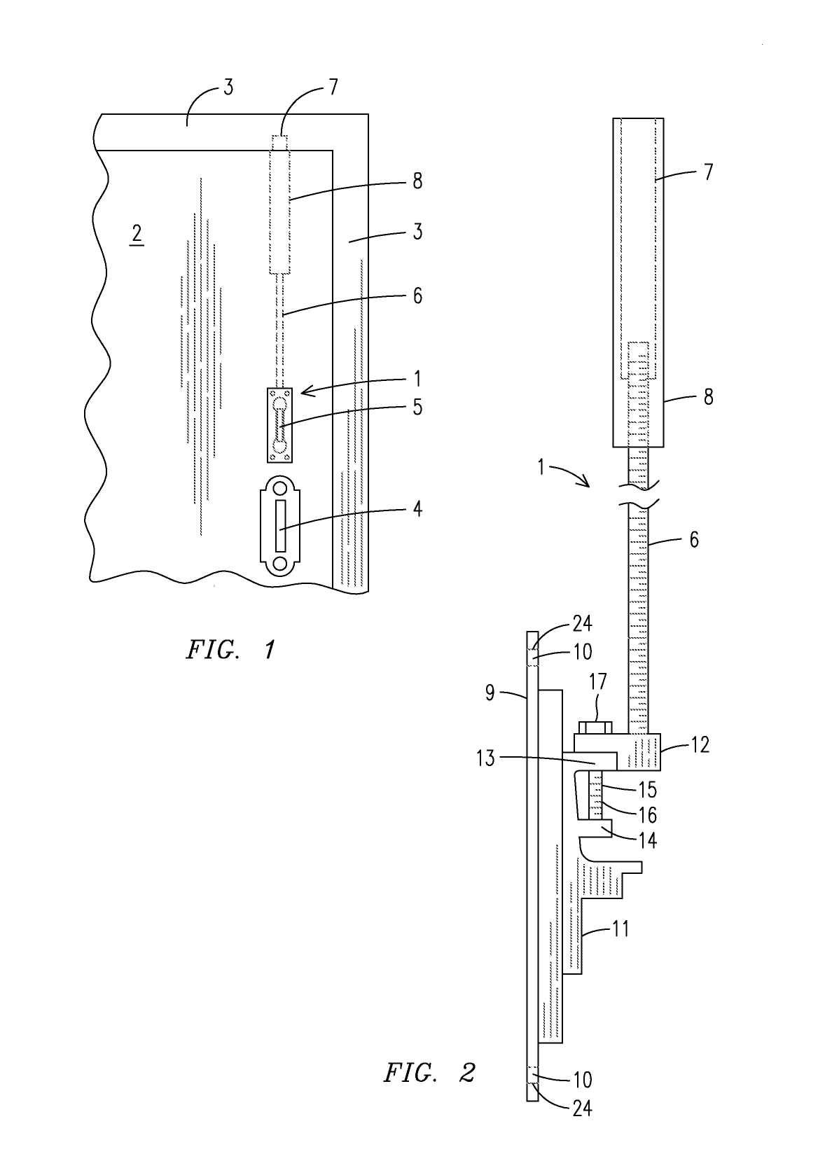

Next, FIGS. 2 and 3 show varying views of the door bolt assembly by itself. The door bolt assembly 1 includes a mounting plate 9 having at least one door fastening means 24 for fastening the mounting plate 9 to the door 2, which may be at least one mounting plate aperture 10 which may accept a screw, bolt or other fastening means. An actuating lever 5 (as shown in FIGS. 1 and 3-5) is pivotally mounted and operably connected to a slidable housing 11 wherein the slidable housing 11 moves in an upward and downward motion when the actuating lever 5 is moved in a downward and upward motion, respectively. The slidable housing 11 also includes a first arm 13 and a second arm 14 that extend a predetermined distance from the slidable housing 11.

A locking block 12 is secured to the slidable housing 11 via a locking means 15, which is preferably a bolt 16. The bolt 16, which has a head 17, extends through the locking block 12, through the first arm 13 and into the second arm 14 so as to maintain the locking block 12 in connection with the slidable housing 11.

The extension rod 6 is connected to the locking block 12 such that the extension rod 6 is operable in an upward and downward motion relative to the door 2 by moving the actuating lever 5. At least one extension support tip 7 may be attached to the extension rod 6 so as to provide an even greater reinforcement structure as compared to utilizing the extension rod 6 alone, as well as extending the length of the extension rod 6. Moreover, at least one extension support tip housing 8 may be utilized to provide even more support by surrounding the extension support tip 7.

The mounting plate 9 preferably includes at least one finger recess 18 located adjacent to the actuating lever 5 to permit a user to quickly and easily rotate the actuating lever 5 in an upward or downward motion.

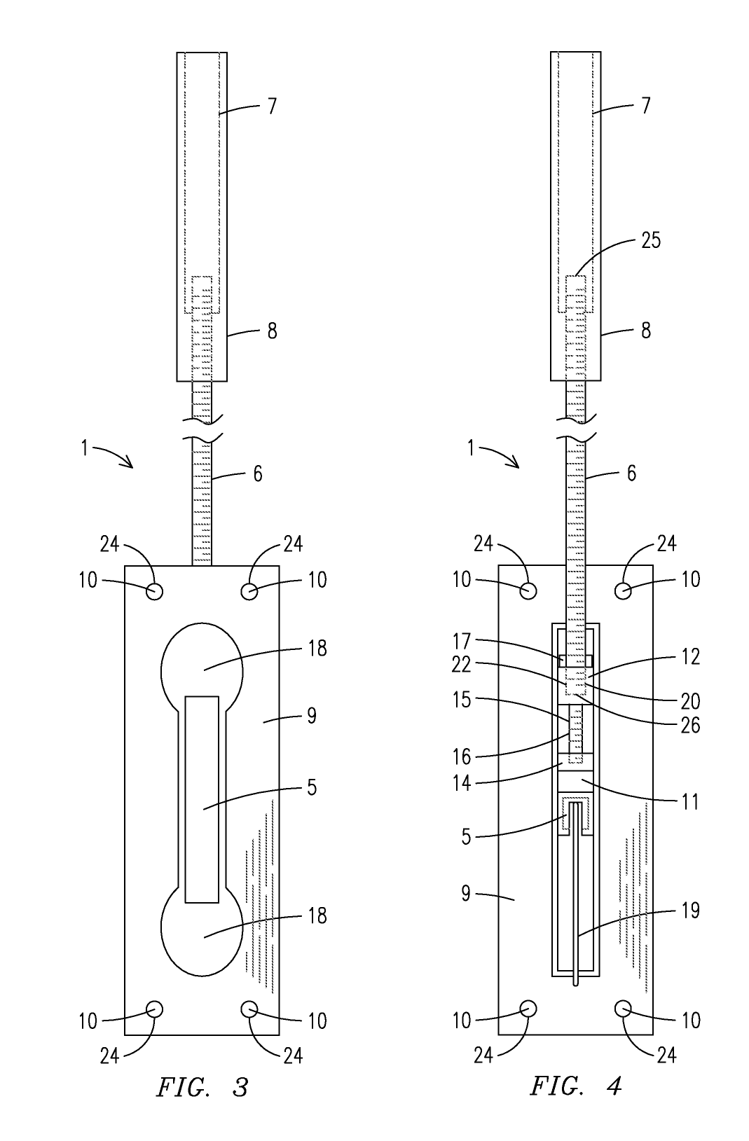

With respect to FIG. 4, a rear plan view of the embodiment of FIG. 2 is shown. The door bolt assembly 1 includes a tension spring 19 secured to the slidable housing 11 that is actuated when the actuating lever 5 is moved. The extension rod 6 has a first end 25 and a second end 26 wherein the extension rod second end 26 extends a predetermined distance into a first arm aperture 27 located on the first arm 13 of the slidable housing 11.

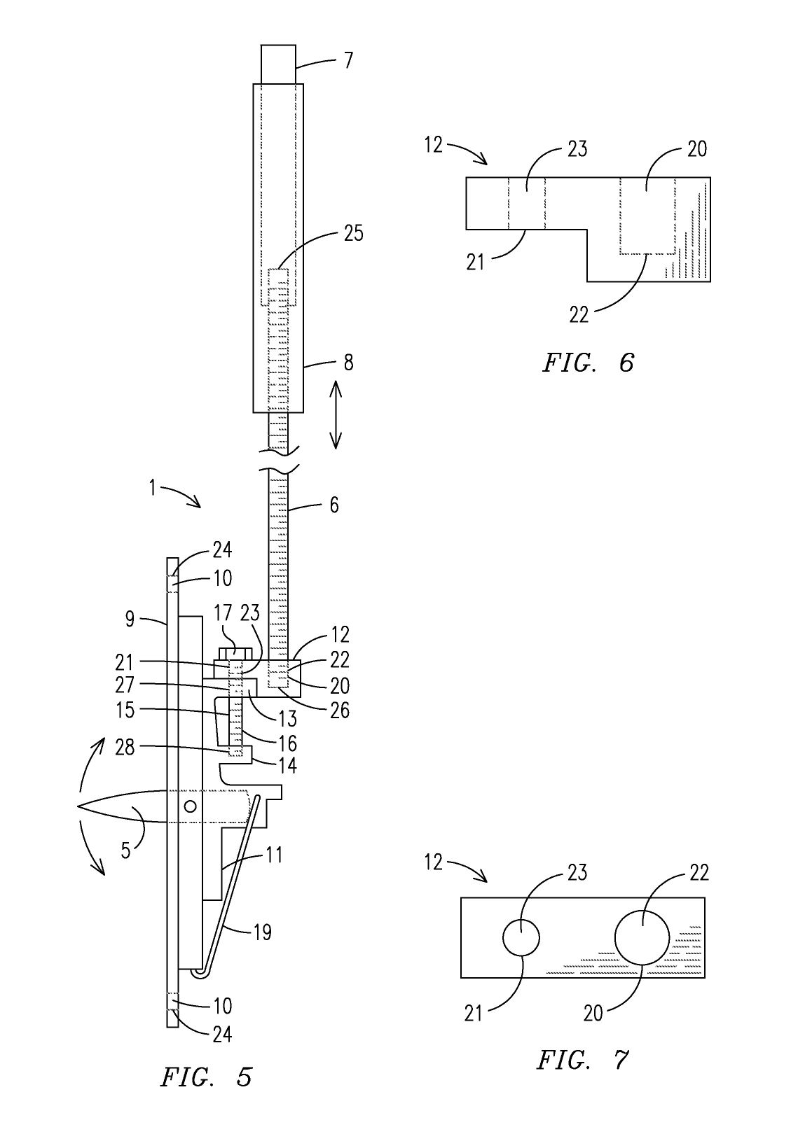

Next, FIG. 5 shows a side plan view of the door bolt assembly of the present invention in use. When the actuating lever 5 is moved in an upward or downward manner, the slidable housing 11 moves in a downward or upward manner, respectively. Because the locking block 12 is connected to the slidable housing 11 and extension rod 6 is connected to the locking block 12, when the actuating lever 11 is moved, the extension rod 6 also moves in an upward or downward motion relative to the door, thereby engaging or disengaging the extension rod 6 and/or extension support tip 7 into the door frame 3.

The extension rod 6 is secured within the extension rod retaining means 20 of the locking block 12, which is preferably a locking block recess 22. Because the extension rod 6 does not pass through the locking block 12 but rather terminates within the locking block 12, the pressure applied on the extension rod 6 will not cause the extension rod 6 to become loose over time as is the common occurrence with most door bolt assemblies. Rather, the extension rod 6 applies pressure on the locking block 12, and, because the extension rod cannot rotate further into the locking block 12, the extension rod 6 maintains its original position within the locking block 12.

The locking block 12 is secured to the slidable housing 11 via the locking means 15, which is preferably a bolt 16, that is inserted through a bolt retaining means 21, which is preferably a locking block aperture 23, into and through the first arm aperture 27 into a second arm recess 28. Although the bolt 16 is shown to extend into the second arm recess 28, the bolt 16 may terminate a predetermined distance above the second arm 14 (not shown).

Finally, FIGS. 6 and 7 show varying views of a locking block of the door bolt assembly of the present invention. The locking block 12 includes an extension rod retaining means 20, which is preferably a locking block recess 22, that extends partially through the locking block 12 a predetermined distance.

The use of the present invention will permit a user to safely secure a door in a closed, locked position while reducing and/or eliminating flexing of the sail area of the door.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A door bolt assembly comprising:
a mounting plate attached to a slidable housing;
said mounting plate having a means for fastening to a door;
an actuating lever pivotally mounted in said slidable housing;
said actuating lever is operably connected to said slidable housing to move said slidable housing in an upward and downward motion;
a locking block secured to said slidable housing via a locking means; and
an extension rod having a first end and a second end wherein said extension rod second end is connected to said locking block such that said extension rod is operable in an upward and downward motion relative to said door by moving said actuating lever.

2. The door bolt assembly of claim 1 wherein:
said locking block has at least one extension rod retaining means and at least one bolt retaining means.

3. The door bolt assembly of claim 2 wherein:
said at least one extension rod retaining means is a locking block recess.

4. The door bolt assembly of claim 2 wherein:
said at least one bolt retaining means is a locking block aperture.

5. The door bolt assembly of claim 3 wherein:
said at least bolt means retaining means is a locking block aperture.

6. The door bolt assembly of claim 1 wherein:
said locking means is a bolt.

7. The door bolt assembly of claim 2 wherein:
said locking means is a bolt.

8. The door bolt assembly of claim 4 wherein:
said locking means is a bolt.

9. The door bolt assembly of claim 5 wherein:
said locking means is a bolt.

10. The door bolt assembly of claim 1 further comprising:
at least one extension support tip securable to said extension rod.

11. The door bolt assembly of claim 1 further comprising:
a first arm and a second arm extend from said slidable housing.

12. The door bolt assembly of claim 11 wherein:
said first arm has at least one first arm aperture.

13. The door bolt assembly of claim 11 wherein:
said second arm has at least one second arm recess.

14. The door bolt assembly of claim 12 wherein:
said second arm has at least one second arm recess.

15. The door bolt assembly of claim 12 wherein:
said locking means extends through said first arm aperture.

16. The door bolt assembly of claim 14 wherein:
said locking means extends through said first arm aperture and into said second arm recess.

17. A door bolt assembly comprising:
a mounting plate attached to a slidable housing;
said mounting plate having a means for fastening to a door;
an actuating lever pivotally mounted in said slidable housing;
said actuating lever is operably connected to said slidable housing to move said slidable housing in an upward and downward motion;
a first arm and a second arm extend from said slidable housing;
said first arm has at least one first arm aperture;
said second arm has at least one second arm recess;
a locking block secured to said slidable housing via a bolt;
said locking block has at least one locking block recess and at least one locking block aperture;
said bolt extends through said locking block aperture and through said first arm aperture into said second arm recess; and
an extension rod having a first end and a second end wherein said extension rod second end extends into said locking block recess such that said extension rod is operable in an upward and downward motion relative to said door by moving said actuating lever.

18. The door bolt assembly of claim 17 further comprising:
at least one extension support tip connected to said extension rod.

19. A method of using a door bolt assembly comprising a mounting plate attached to a slidable housing; said mounting plate having a means for fastening to a door; an actuating lever pivotally mounted in said slidable housing; said actuating lever is operably connected to said slidable housing to move said slidable housing in an upward and downward motion; a locking block secured to said slidable housing via a locking means; and an extension rod having a first end and a second end wherein said extension rod second end is connected to said locking block such that said extension rod is operable in an upward and downward motion relative to said door by moving said actuating lever, said method comprising the steps of:
a. closing said door to be bolted;
b. positioning said actuating lever in a downward position to engage said extension rod;
c. positioning said actuating lever in an upward position to disengage said extension rod; and
d. opening said door.
